(19) United States
(12) Patent Application Publication
(10) Pub. No.: US 2026/0164331 A1
(43) Pub. Date: Jun. 11, 2026

(54) FIXED ROUTE DETECTION AND MOBILITY OPTIMIZATION

(71) Applicant: QUALCOMM Incorporated, San Diego, CA (US)

(72) Inventors: Shanshan WANG, San Diego, CA (US); Reza SHAHIDI, La Jolla, CA (US); Yongle WU, San Diego, CA (US); Ertugrul Necdet CIFTCIOGLU, North Reading, MA (US); Liangchi HSU, San Diego, CA (US)

(21) Appl. No.: 18/974,655

(22) Filed: Dec. 9, 2024

(51) Int. Cl. H04W 36/32; H04W 36/00

(52) U.S. Cl. CPC H04W 36/322; H04W 36/00833

(57) ABSTRACT

A method for wireless communication at a user equipment (UE) and related apparatus are provided. In the method, the UE identifies an update to the initial route for the UE based on a first end of an initial route and a second end of the initial route. The UE further selects a subset of network cells from a set of network cells for communication with a network entity based on the update to the initial route. Following this selection, the UE communicates with the network entity using the selected subset of network cells.

### TECHNICAL FIELD

The present disclosure relates generally to communication systems and, more particularly, to enhancements in wireless communication through the detection of routes.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to identify, based on a first end of an initial route and a second end of the initial route, an update to the initial route for the UE; select, based on the update to the initial route, a subset of network cells from the set of network cells for communication with a network entity; and communicate with the network entity via the subset of network cells.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to communicate with a UE via a set of network cells during initial communications; and communicate with the UE in a subsequent communication via a subset of network cells in a set of network cells, where the subset of network cells is selected from the set of network cells based on a set of visit counts from the initial communications respectively corresponding to the set of network cells, a first end of an initial route, and a second end of the initial route.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of tracking cell visit counts in accordance with various aspects of the present disclosure.

FIG. 5 is a diagram illustrating a wireless communication method in accordance with various aspects of the present disclosure.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

Many people regularly follow fixed routes to work, shopping centers, and other destinations. However, specific network cells along these routes may often encounter issues that consistently affect the performance of user devices, such as a user equipment (UE). By identifying these routes and tuning the mobility strategy along these routes, users may be directed away from these problematic network cells. Example aspects presented herein provide methods and apparatus to detect common routes and select favorite cells along these routes.

Various aspects relate generally to wireless communication. Some aspects more specifically relate to the detection of fixed routes and the optimization of mobility strategies along these routes. In some examples, a UE identifies an update to the initial route for the UE based on a first end of an initial route and a second end of the initial route. The UE further selects a subset of network cells from a set of network cells for communication with a network entity based on the update to the initial route. Following this selection, the UE communicates with the network entity via the selected subset of network cells. In some examples, the UE may identify at least one of the first end of the initial route or the second end of the initial route based on a usage metric of the UE, which may include the connection duration, the connection type, or the mobility level of the UE. In some examples, each visit count in the set of visit counts may include the accumulation of multiple individual counts respectively located in multiple adjustable time bins within a period of time, and the multiple time bins are distributed in the period of time based on an interval. In some examples, the UE may concatenate the network cells in the set of network cells having the highest numbers of visit counts between the first end and the second end to form the subset of network cells. In some examples, the UE may identify multiple sequences of network cells between the first end and the second end from the set of network cells, and select one sequence of network cells from the multiple sequences of network cells as the subset of network cells, and the one sequence of network cells may have the highest sequence count in the multiple sequences of network cells.

Particular aspects of the subject matter described in this disclosure can be implemented to realize one or more of the following potential advantages. In some examples, by detecting frequently traveled routes and customizing the mobility strategy specifically for these detected routes, the described techniques may be used to detect distinct travel patterns and enhance user experiences and device functionalities during routine commutes. In some examples, by determining the routes based on cell visit counts within various time bins that reflect daily and weekly variations, the described techniques adapt to varying user schedules and mobility patterns, thereby improving the accuracy of route determination. In some examples, by choosing the highest-performing cells along these determined routes and avoiding problematic cells, the described techniques significantly enhance both the reliability and efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

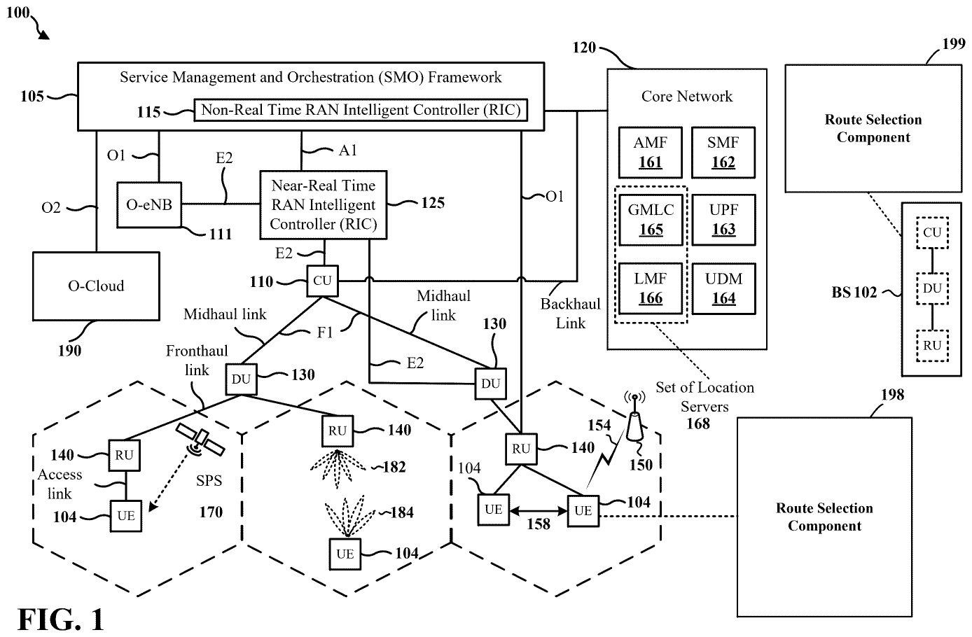

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a route selection component 198. The route selection component 198 may be configured to identify, based on a first end of an initial route and a second end of the initial route, an update to the initial route for the UE; select, based on the update to the initial route, a subset of network cells from the set of network cells for communication with a network entity; and communicate with the network entity via the subset of network cells. In certain aspects, the base station 102 may include a route selection component 199. The route selection component 199 may be configured to communicate with a UE via a set of network cells during initial communications; and communicate with the UE in a subsequent communication via a subset of network cells in a set of network cells, where the subset of network cells is selected from the set of network cells based on a set of visit counts from the initial communications respectively corresponding to the set of network cells, a first end of an initial route, and a second end of the initial route. Although the following description may be focused on 5G NR, the concepts described herein may be applicable to other similar areas, such as LTE, LTE-A, CDMA, GSM, and other wireless technologies.

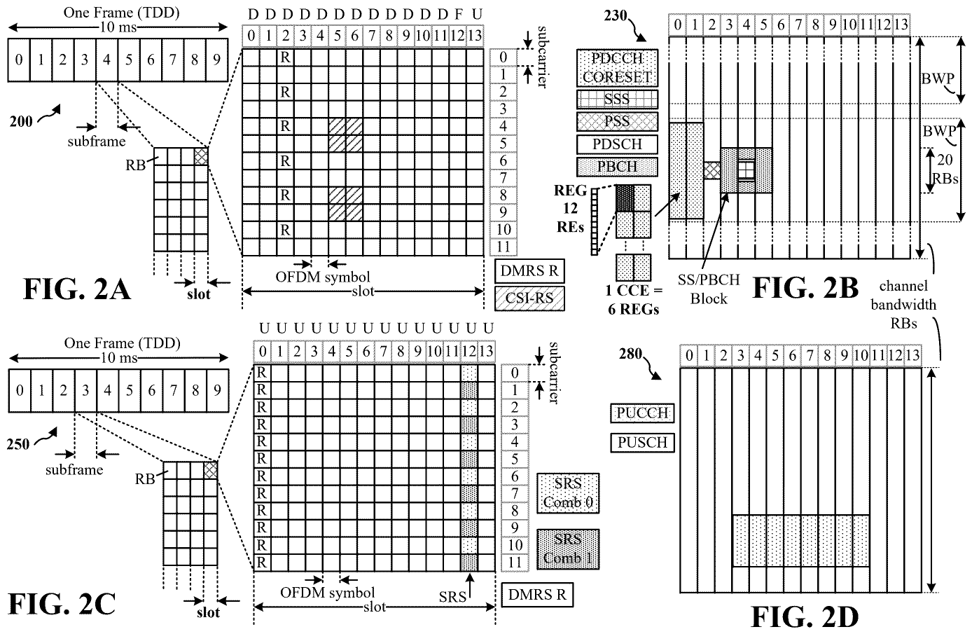

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

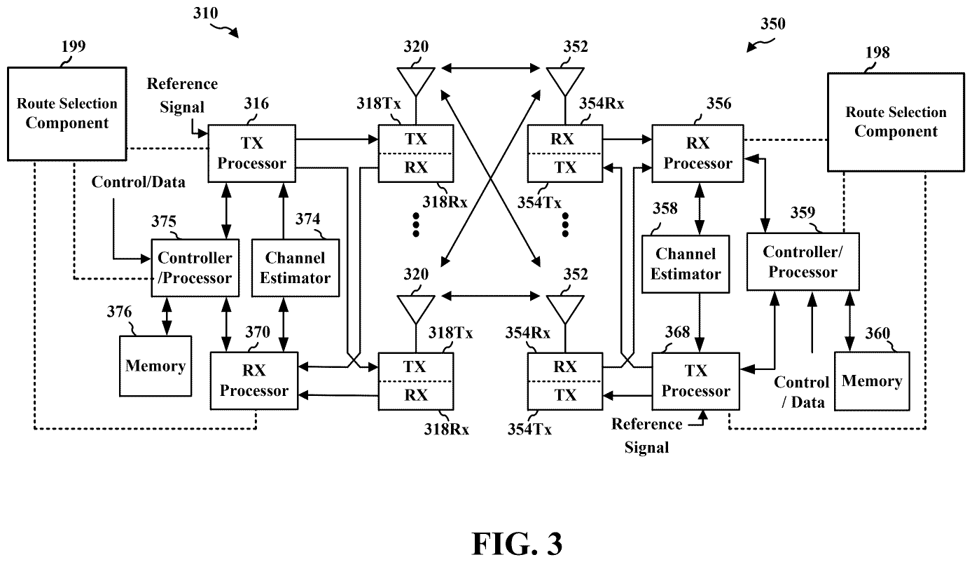

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the route selection component 198 of FIG. 1.

At least one of the TX processor 316, the RX processor 370, and the controller/processor 375 may be configured to perform aspects in connection with the route selection component 199 of FIG. 1.

Many people regularly follow fixed routes to work, shopping centers, and other destinations. However, specific network cells along these routes may often encounter issues that consistently affect the performance of user devices, such as a UE. By identifying these routes and tuning the mobility strategy along these routes, users may be directed away from these problematic network cells. Example aspects presented herein provide methods and apparatus to detect common routes and select favorite cells along these routes. In some examples, based on weighted cell scores, which may be based on metrics such as visit counts or quality of coverage for each cell, a set of preferred cells may be selected from a larger set of cells along the detected common routes to ensure optimized cell coverage along these routes. As used herein, the terms “fixed route,” “common route,” or “regular route” refer to a travel path that a wireless device, such as a mobile phone, often follows according to a consistent pattern, for example, traveling at consistent times throughout the week.

A typical route may be defined by two endpoints: a “start” point and an “end” point, which may also be referred to as the first end and the second end, in some aspects. For example, the home may represent the “start” point and the office may present the “end” point. In some aspects, a UE may determine the “start” and “end” of a fixed route based on various usage metrics of the UE.

In some aspects, the usage metrics may include the dwell time of the UE (e.g., the duration a UE stays connected to a particular cell). For example, locations where the UE remains connected to a cell global identity (CGI) for prolonged dwell times (e.g., exceeding a duration threshold) on a daily or weekly basis may be regular visit locations, such as a home or office. These locations may serve as the “start” or “end” points of a regular route.

In some aspects, the usage metrics may include the connection type of the UE, such as whether the UE is connected via a Wi-Fi connection or a cellular connection. For example, establishing a stable connection to a non-moving, non-hotspot Wi-Fi network may indicate the “end of the route” when the UE reaches places like a home or an office. On the other hand, the disconnection from such a Wi-Fi connection may indicate the “start of route” when the UE departs these locations.

In some aspects, the usage metrics may include the mobility level of the UE (e.g., the amount of movement or activity of the UE). For example, a significant change in the mobility level of the UE at a location from lower to higher mobility, or vice versa, may indicate this location is the beginning or end of a route. The mobility level of a UE may be accessed using various parameters, such as the UE's speed (e.g., the speed based on the global positioning system (GPS)), patterns of cell switching, displacement variations or changes, changes in signal patterns, or sensor readings that indicate movement or stillness.

In some aspects, the route detection process may involve segmenting time into various time bins and tracking the number of visits to network cells within each time bin. Table 2 shows example time bins in accordance with various aspects of the present disclosure. As shown in Table 2, each time bin may have a duration of one hour, effectively splitting a day into up to 24 separate time bins. Additionally, each time bin may correspond to one day of a week, such as Monday, Tuesday, and so forth. The frequency of visits to a set of network cells may be accessed based on the visit counts collected within these time bins.

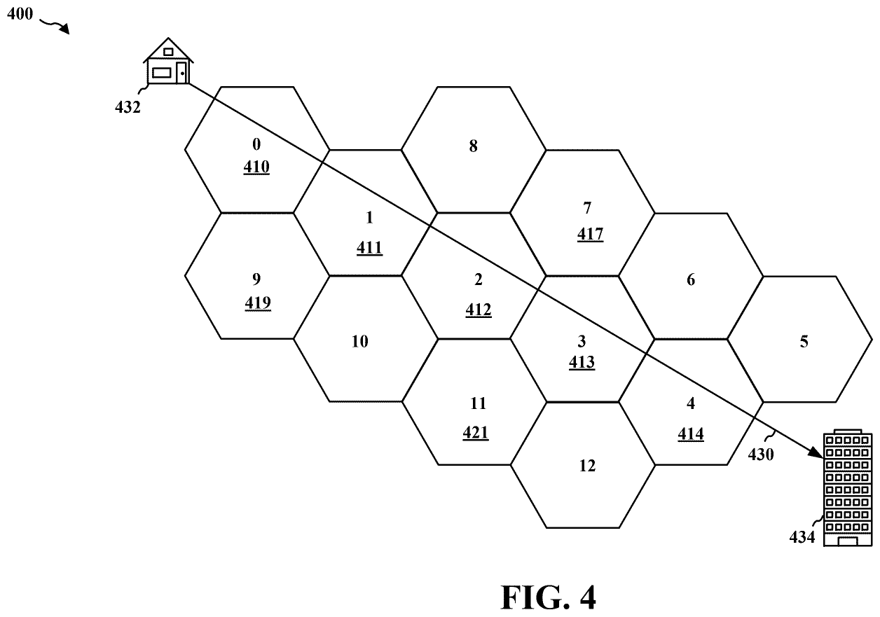

The segmentation of the time bins allows for real-time tracking of cell visit counts, which may vary by day of the week and specific time windows within each day, adapting to the differing travel patterns of users. For example, analyzing the cell visit counts during the 7-8 am window on Mondays may reflect the commuting patterns of the users. In some examples, these time bins do not need to have uniform durations. For example, during peak travel hours, such as 6-10 am or 4-8 pm, the duration of the time bins may be shorter (e.g., 15 minutes) to gather more detailed data. Additionally, the UE may adjust its monitoring of the cell visit counts to align with the user's activity patterns, such as distinguishing between weekdays and weekends, or between workdays and non-workdays. This approach allows for an adaptive analysis of travel patterns on days with regular routes but different activities, such as non-workdays. Based on these time bins, the UE may have the flexibility to concentrate the cell visit counts on particular time periods or groups of days as necessary. Table 3 shows the examples of the statistics on the cell visit count over a period of time. In some aspects, when counting the cell visit count, multiple repeated visits to the same cell within the same time bin may be counted as a single visit. For example, if there is a ping-pong effect (or ping-pong mobility) between cells, where a UE frequently switches between two cells due to, for example, fluctuating signal quality, these repeated visits to a cell may be counted as one visit. This approach may help to prevent the overestimation of the cell visit counts and ensure the accuracy of the route determination. FIG. 4 is a diagram 400 illustrating an example of tracking the cell visit counts in accordance with various aspects of the present disclosure. In some examples, as shown in Table 3 and FIG. 4, the UE may obtain statistics on the cell visit count for various network cells on a route 430 between the home 432 and the office 434 over a period of time (e.g., NUM_ENTRY). For example, as shown in Table 3, over a period of 20 weeks, the total cell visit counts for various network cells around the route 430, such as cell 0 410, cell 1 411, cell 2 412, cell 3 413, cell 4 414, recorded at a specific time of the day (e.g., 7-8 am) on a specific day of the week (e.g., Monday) may be 20, 20, 18, 18, and 15, respectively. This statistics data may track the cell visit counts in particular time bins (e.g., the time bin for 7-8 am), on a specific day of the week (e.g., Monday) across the period of time (e.g., multiple weeks).

In some examples, cell visit counts may be processed in real-time without the need for local databases to store the data, as the cell visit counts may be directly accumulated in a set of variables. In some examples, for enhanced functionality or specific use cases, a database may be constructed. This allows for subsequent lookups and a more detailed analysis of the accumulated data as needed.

TABLE 2
Example time bins of a given day-of-week

| | 1 | . . . | 7 | 8 | . . . | 19 | . . . | 24 |
|---|---|---|---|---|---|---|---|---|
| | 12-1 | . . . | 6-7 | 7-8 | . . . | 6-7 | . . . | 11-12 |
| | am | | am | am | | pm | | pm |
| Monday | Time | . . . | Time | Time | . . . | Time | . . . | Time |
| | bin 1 | | bin 7 | bin 8 | | bin | | bin |
| | | | | | | 19 | | 24 |
| Tuesday | Time | . . . | Time | Time | . . . | Time | . . . | Time |
| | bin | | bin | bin | | bin | | bin |
| | 25 | | 31 | 32 | | 43 | | 48 |
| Wednesday | . . . | | | | | | | |
| Thursday | | | | | | | | |
| Friday | | | | | | | | |
| Saturday | | | | | | | | |
| Sunday | | | | | | | | |

TABLE 3
Example statistics on the cell visit counts over a period of time

| | | Data | Time | | Cell Visit Count Update | | | | |
|---|---|---|---|---|---|---|---|---|---|
| | | of | of day | Camped | Cell | Cell | Cell | Cell | Cell |
| | | Week | (bin) | Cells | 0 | 1 | 2 | 3 | 4 |
| NUM | Week | Monday | 7- | 0, 1, 2, 3 | 1 | 1 | 1 | 1 | |
| [symbol] | n | | 8am | | | | | | |
| | Week | | | 0, 1, 2, 3, 4 | 2 | 2 | 2 | 2 | 1 |
| | n + 1 | | | | | | | | |
| | Week | | | 0, 1, 10, 2, 3, 4 | 3 | 3 | 3 | 2 | 1 |
| | n + 2 | | | | | | | | |
| | Week | | | 0, 1 | 4 | 4 | | | |
| | n + 3 | | | | | | | | |
| | Week | | | 0, 1, 10, 2, 3 | 5 | 5 | 4 | 4 | |
| | n + 4 | | | | | | | | |
| | Week | | | 0, 1, 2, 3 | 6 | 6 | 5 | 5 | |
| | n + 5 | | | | | | | | |
| | . . . | | | . . . | . . . | . . . | . . . | . . . | . . . |
| | Week | | | 0, 1, 2 | 20 | 20 | 18 | 18 | 15 |
| | n + 20 | | | | | | | | |

[symbol]

indicates data missing or illegible when filed

In some aspects, the UE may select a subset of network cells from a larger set of network cells by linking (or concatenating) the network cells in the set of network cells that have the highest visit counts between the two ends (e.g., the “start” and “end” points). In some examples, this selection process may be performed in a recursive manner based on the cell visit counts for the set of network cells. For example, the selection of the subset of network cells may start at one end (e.g., home 432) by selecting one network cell (e.g., cell 0 410) from the set of network cells that has the highest cell visit count at that end. The UE then identifies neighbor network cells (e.g., cell 1 411 and cell 9 419) of the selected network cell based on, for example, the search and measurement results. From these neighbor cells (e.g., cell 1 411 and cell 9 419), the UE may select one network cell (e.g., cell 1 411) with the highest cell visit count and add it to the subset of network cells. This process of identifying and adding network cells to the subset of network cells may continue iteratively until the opposite end of the route (e.g., office 434) is reached. In the example of Table 3, by concatenating the network cells with the highest cell visit counts, the subset of network cells connecting the home 432 and the office 434 may include cell 0 410, cell 1 411, cell 2 412, cell 3 413, cell 4 414. In some examples, this concatenation of network cells may be performed based on the cell visit counts span across multiple time bins (instead of a single time bin). For example, the UE may specify a “time window,” which may be adjustable and may include multiple time bins. The subset of network cells may then be selected from the set of network cells based on the cell visit counts within this time window.

In some aspects, the UE may select a subset of network cells from a larger set of network cells based on the sequence counts for multiple sequences of network cells that connects the two ends of a route. The “sequence count” refers to the count of a specific sequence of network cells is used by the UE when traveling a route (e.g., from home 432 to office 434). This approach focuses on identifying a route as the sequence of network cells that the UE most frequently visits between the “start” and “end” points.

Table 4 shows the example sequence counts for a UE as it travels a specific route. For example, the process of selecting the subset of network cells involves mapping out all possible sequences of sequentially camped network cells between the “start” and “end” points of the route. For example, as shown in Table 4, possible sequences may include: S1={0, 1, 2, 3, 4}, S2={0, 1, 10, 2, 3, 4}, and S3={0, 1, 2, 11, 12, 4}, where each number (e.g., 0, 1, 2) represents a cell (e.g., cell 0 410, cell 1 411, cell 2 412). The occurrences of each sequence (e.g., the “sequence count”) over a period of time (e.g., 20 weeks) may be recorded, and the identified subset of network cells will then be the sequence of network cells that has the highest sequence count, indicating it is the path most commonly traveled by the user. In the example of Table 4, assuming the sequence counts for various sequences are S1=12, S2=5, and S3=1, with S1 having the highest sequence count, the subset of network cells may be the network cells in most traveled sequence, S1, which includes cell 0 410, cell 1 411, cell 2 412, cell 3 413, and cell 4 414.

In some aspects, in the process of selecting network cells along a route, the UE may predict whether it is following a regular route (e.g., a previously identified route) by analyzing various factors. In some examples, the UE may predict a regular route if there is a match between the current “start” point or start CGI with that of a previously identified route. In some examples, the UE may predict that it is traveling on a regular route by comparing the network cells it visits with the network cells associated with a previously identified route. For example, if the number of visited network cells exceed a predefined threshold associated with a previously identified route, the UE may predict that it is traveling on the previously identified route. In some examples, the prediction may also be based on the travel time of the UE. For example, when travel time (e.g., the time of day or the data of the week of the travel) matches a typical travel time associated with a previously identified route, the UE may predict that it is traveling on the identified route. In some examples, a change in connection type, such as switching from a long-connected Wi-Fi network to cellular service, may also suggest movement along a regular route.

TABLE 4
Example sequence counts for a UE traveling along a route

| | | Day of | Start/End | Camped Cells (can be |
|---|---|---|---|---|
| | | Week | of Route | across multiple time bins) |
| NUM_{—} | Week n | Monday | Start = | S1 = {0, 1, 2, 3, 4} |
| ENTRY | Week n + 1 | | Cell 0 | S1 = {0, 1, 2, 3, 4} |
| | Week n + 2 | | End = | S2 = {0, 1, 10, 2, 3, 4} |
| | Week n + 3 | | Cell 4 | S1 = {0, 1, 2, 3, 4} |
| | Week n + 4 | | | S2 = {0, 1, 10, 2, 3, 4} |
| | Week n + 5 | | | S3 = {0, 1, 2, 11, 12, 4} |
| | . . . | | | |
| | Week n + 20 | | | S2 = {0, 1, 10, 2, 3, 4} |

In some aspects, the selection of the subset of network cells along a route may be based on a weighted cell score (WCS) associated with each network cell in the set of network cells. As an example, the WCS for any given network cell, such as cell A, may be calculated by modifying its basic cell score with additional factors that reflect its suitability and reliability. For example, the WCS of cell A may be calculated by: WCS (A)=Cell Score (A)−DoP (A)+PreF (A), where DoP (A) is the degree of problem metric for cell A, and Pref (A) is the desired factor for cell A.

The cell score for cell A may be derived based on quality metric associated with the cell, such as signal quality indicators like reference signal received power (RSRP) and reference signal received quality (RSRQ) for cell A. In some examples, the cell score for cell A may consider factors such as the cell bandwidth, the MIMO layer configuration, and the signal-to-noise ratio (SNR) associated with the cell. The desired factor of cell A (e.g., PreF (A)) may be based on several factors. For example, Pref (A) may be higher if cell A has a frequent visitation history (e.g., a high cell visit count), is recommended to be a desired cell (e.g., by the original equipment manufacturer (OEM) or an internal algorithm), or if cell A belongs to a radio access technology (RAT) that provides coverage for upcoming segments of the route. For example, if a coverage gap (or coverage hole) for one RAT (e.g., new radio (NR)) is anticipated, a cell associated with another RAT that does not have this coverage gap (e.g., LTE) may be desired.

In some examples, the degree of problem metric on cell A (e.g., DoP (A)) may be calculated as a weighted sum of issues observed in that network cell. For example, the issues may include one or more of the data stalls, radio link failures (RLF), the connection establishment failure, the failure to receive important configurations, the presence of ping-pong mobility, or the misconfiguration by the network, and other performance degradations associated with the network cell. This factor subtracts from the cell score, reflecting the potential drawbacks of selecting this cell based on past issues.

In some aspects, the UE may select the subset of network cells from a set of network cells along a route based on the WCS of each network cell, so that the best possible connectivity and service quality may be maintained throughout the route. In some examples, when multiple network cells present the same WCS, the decision-making process may include evaluating the next-hop neighbor cells (e.g., the immediately adjacent cells) of these cells. In some examples, the network cell whose next-hop neighbors collectively have the highest WCS sum may be chosen over the network cell whose next-hop neighbor collectively have a smaller WCS sum.

For example, referring to FIG. 4, consider a scenario where the UE is at cell 2 412, and it needs to choose between cell 7 417 and cell 11 421, both of which have the same WCS. If the sum of the WCS values for the neighbor cells of cell 7 417 is less than that for the neighbor cells of cell 11 421, it indicates that cell 11 421 is surrounded by more reliable cells. Consequently, cell 11 421 would be a better choice for the UE to camp on next, as its neighbors are less likely to present problems. In another scenario, even if the WCS of cell 11 421 might be slightly lower than that of cell 7 417, cell 11 421 may still be selected if its next-hop neighbor cells present the higher cumulative WCS, suggesting fewer overall problems compared to the neighbors of cell 7 417.

In some aspects, when selecting the subset of network cells from the set of network cells along a route, the UE may determine or adjust which RAT to utilize for optimal connectivity. For example, if the UE identifies that the area two hops away (e.g., the area after two adjacent neighbor cells) predominantly supports one RAT (e.g., LTE), it may begin to search for network cells with good connections for that RAT in the vicinity as it moves to the next hop. In some examples, to facilitate this RAT selection, the UE may modify regular mobility procedures such as cell reselection or selection procedure. In some examples, the UE may enforce a search based on the desired RAT by overriding certain priority settings. This could involve changing the reselection priority to favor one RAT (e.g., LTE), altering the order and priority of measurement reports, or adjusting the RAT scanning order and desires. Such adjustments make it easier for the UE to target a certain RAT (e.g., LTE), thereby enhancing the overall mobility experience as it navigates through different network environments along its route.

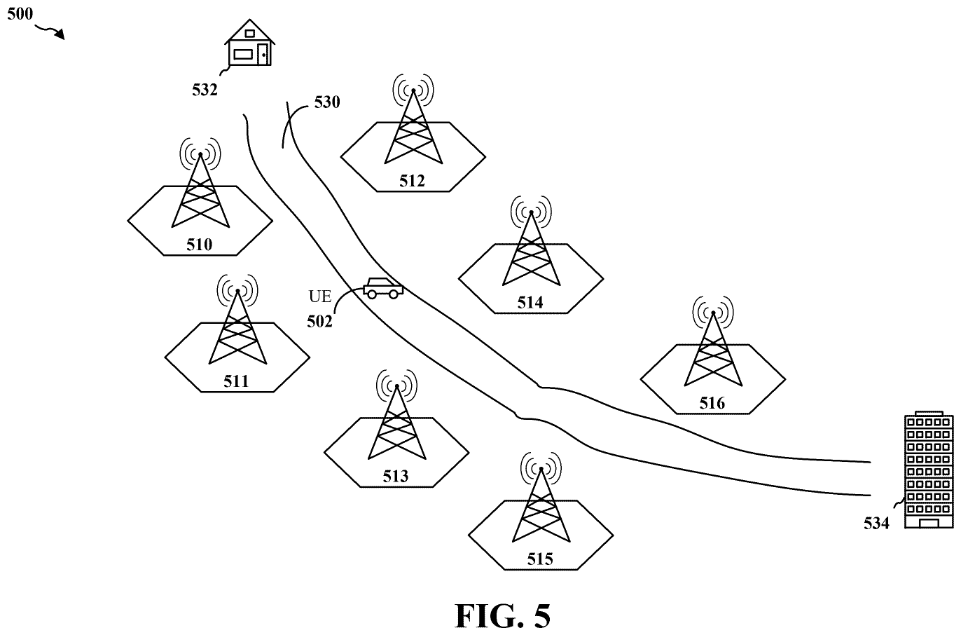

FIG. 5 is a diagram 500 illustrating a wireless communication method in accordance with various aspects of the present disclosure. As shown in FIG. 5, a UE 502 may travel along a route 530, which may be, for example, from home 532 to office 534. There may be a set of network cells along the route 530, including cells 510, 511, 512, 513, 514, 515, and 516. The UE 502 may record which network cells have been used for communication in previous travels along the route 530. For example, the usage of the network cells along the route 530 may be recorded based on multiple time bins, each representing a certain time interval (e.g., one hour) within a specific day of the week (e.g., Monday).

The UE 502 may identify that the route it is traveling (e.g., route 530) is a previously identified route based on various factors, such as the start point of the route (e.g., home 532), the change in connection type (e.g., from a Wi-Fi to a cellular connection), or the travel time. Once the UE 502 identifies the route it is traveling as a previously identified route, the UE 502 may select a subset of network cells from the set of network cells along the route 530 for its communication. In some examples, the UE 502 may select the subset of network cells by concatenating the network cells in the set of network cells having the highest number of visit counts between two ends of the route 530, such as home 532 and office 534. In some examples, the UE 502 may select the subset of network cells by selecting a sequence of network cells that connects the two ends of the route 530 and has the highest sequence count among all recorded sequences. In some examples, the UE 502 may select a subset of network cells from the set of network cells along the route 530 based on the WCS associated with each network cell in the set of network cells. For example, the WCS of a network cell may reflect the reliability of the corresponding cell (e.g., the less issue encountered in the previous communication for a network cell, the higher the WCS for that network cell). In some examples, when selecting the subset of network cells, the UE 502 may also consider the RAT associated with each network cell and proactively select the network cell to facilitate the reliable communication. For example, if one network cell is associated with one RAT (e.g., LTE) that is anticipated to have a coverage gap (or coverage hole) along the route 530, the UE 502 may avoid selecting this network cell and select another network cell associated with another RAT that does not have such a coverage gap (or coverage hole). Based on the selected subset of network cells, the UE 502 may communicate with the network along the route 530.

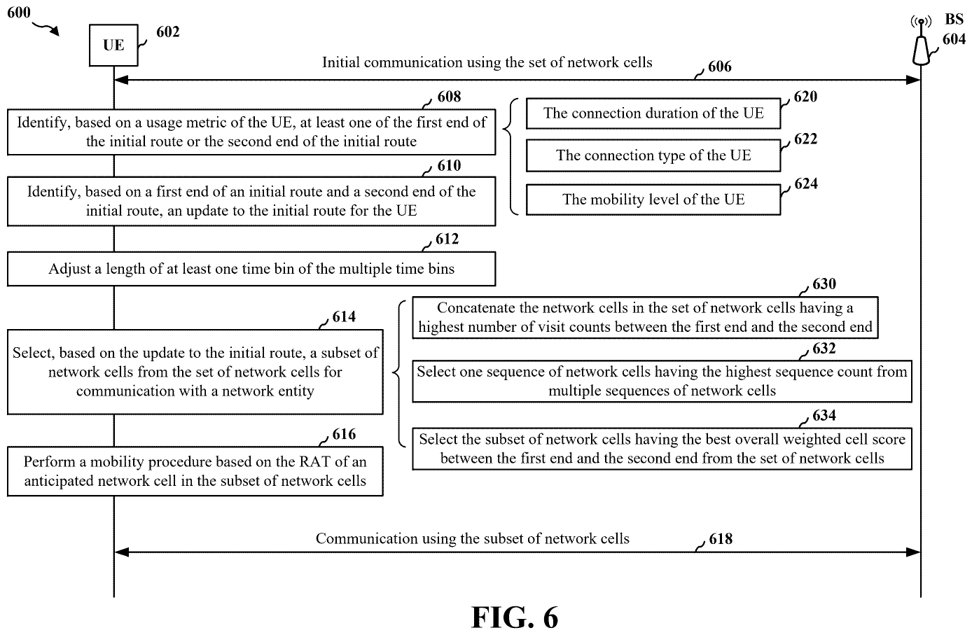

FIG. 6 is a call flow diagram 600 illustrating a method of wireless communication in accordance with various aspects of this present disclosure. Various aspects are described in connection with a UE 602 and a base station 604. The aspects may be performed by the UE 602 or the base station 604 in aggregation and/or by one or more components of a base station 604 (e.g., a CU 110, a DU 130, and/or an RU 140).

As shown in FIG. 6, at 606, the UE 602 may have initial communication with the base station 604 using a set of network cells. For example, referring to FIG. 5, the UE 502 may have initial communication with the base station using a set of network cells, such as cell 510, 511, 512, 513, 514, 515, 516. In some examples, the number of the network cells that have been used by the UE 502 in a certain time interval (or time bins) within a specific day of the week (e.g., Monday) may be recorded. The recorded usage of the network cells may assist the UE 502 in selecting the most appropriate network cell for communication when it travels along the same route again.

At 608, the UE 602 may identify at least one of the first end of the initial route or the second end of the initial route based on a usage metric of the UE 602. In some examples, the usage metric of the UE 602 may include one or more of: the connection duration of the UE 602 (e.g., 620), the connection type of the UE 602 (e.g., 622), or the mobility level of the UE 602 (e.g., 624). For example, a prolonged connection duration at a location may indicate that this location is one end of a route (e.g., home 532 or office 534). For example, a change of the connection type (e.g., from Wi-Fi connection to cellular connection) at a location may indicate that this location is one end of a route (e.g., home 532 or office 534).

At 610, the UE 602 may identify an update to the initial route for the UE 602 based on a first end of an initial route and a second end of the initial route. For example, referring to FIG. 5, if the UE 502 identifies that the start location of the route is home 532, this may suggest that the UE 502 is likely to be traveling along the route 530. In some examples, the UE 602 may identify the visit counts for each network cell in the set of network cells in a set of multiple adjustable time bins. In some examples, at 612, the UE 602 may adjust the length of at least one time bin of the multiple time bins. For example, referring to FIG. 5, the UE 502 may identify the visit counts for each network cell (e.g., cells 510, 511, 512, 513, 514, 515, 516) in the set of network cells in a set of multiple adjustable time bins. Referring to Table 2, each time bin (e.g., time bin 1, time bin 2) may have an adjustable duration (e.g., one hour).

At 614, the UE 602 may select, based on the update to the initial route, a subset of network cells from the set of network cells for communication with the base station 604.

In some examples, to select the subset of network cells from the set of network cells, the UE 602 may, at 630, concatenate the network cells in the set of network cells having the highest number of visit counts between the first end and the second end. For example, referring to FIG. 4 and Table 3, based on the cell visit counts for the network cells, the selected subset of network cells may include cell 0 410, cell 1 411, cell 2 412, cell 3 413, and cell 4 414, which have the highest visit counts among the cells that connect the two ends of the route (e.g., home 432 and office 434).

In some examples, to select the subset of network cells from the set of network cells, the UE 602 may, at 632, select one sequence of network cells having the highest sequence count from multiple sequences of network cells. For example, referring to Table. 4, the UE may select sequence S1={0,1,2,3,4} (each number represents one cell) of network cells since the sequence S1 has a higher sequence count than other sequences of network cells (e.g., S2={0,1,10,2,3,4} or S3={0,1,2,11,12,4}).

In some examples, to select the subset of network cells from the set of network cells, the UE 602 may, at 634, select the subset of network cells having the best overall weighted cell score (WCS) between the first end and the second end from the set of network cells. For example, referring to FIG. 5, each network cell in the set of network cells (e.g., cells 510, 511, 512, 513, 514, 515, 516) may have an associated WCS, and the UE 502 may select the subset of network cells from the set of network cells based on their WCS.

In some aspects, at 616, the UE 602 may perform a mobility procedure based on the RAT of an anticipated network cell in the subset of network cells. For example, referring to FIG. 5, if a cell (e.g., cell 514) belongs to a RAT that provides coverage for upcoming segments of the route, and a coverage gap (or coverage hole) for that RAT is anticipated, a cell associated with another RAT that does not have this coverage gap (e.g., cell 513) may be selected.

At 618, the UE 602 may communicate with the base station 604 using the selected subset of network cells.

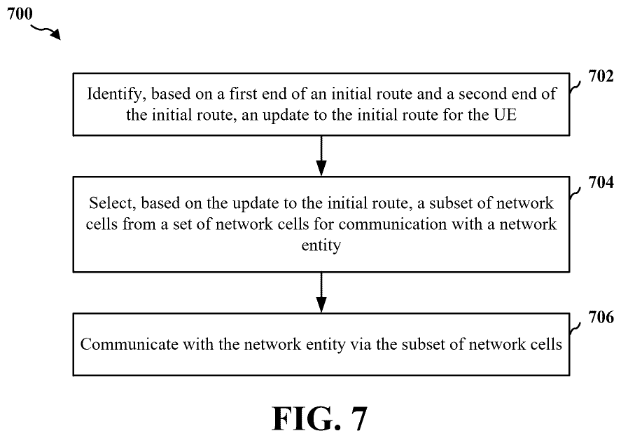

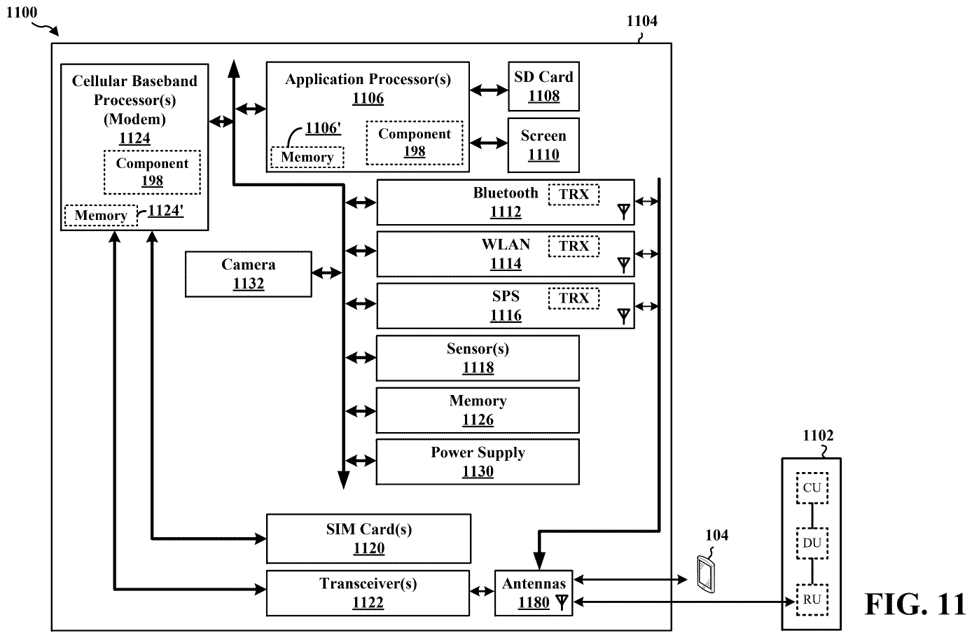

FIG. 7 is a flowchart 700 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 502, 602, or the apparatus 1104 in the hardware implementation of FIG. 11. By detecting frequently traveled routes and customizing the mobility strategy specifically for these detected routes, the methods may be used to detect distinct travel patterns and enhance user experiences and device functionalities during routine commutes. Additionally, by determining the routes based on cell visit counts within various time bins that reflect daily and weekly variations, the methods adapt to varying user schedules and mobility patterns, thereby improving the accuracy of route determination. In some examples, by choosing the highest-performing cells along these determined routes and avoiding problematic cells, the methods significantly enhance both the reliability and efficiency of wireless communication.

As shown in FIG. 7, at 702, the UE may identify an update to the initial route for the UE based on a first end of an initial route and a second end of the initial route. FIG. 4, FIG. 5, and FIG. 6 illustrate various aspects of the steps in connection with flowchart 700. For example, referring to FIG. 6, the UE 602 may, at 610, identify an update to the initial route for the UE 602 based on a first end of an initial route and a second end of the initial route. Referring to FIG. 5, if the UE 502 identifies that the start location of the route is home 532, this may suggest that the UE 502 is likely to be traveling along the route 530. In some aspects, 702 may be performed by the route selection component 198.

At 704, the UE may select a subset of network cells from a set of network cells for communication with a network entity based on the update to the initial route. For example, referring to FIG. 6, the UE 602 may, at 614, select a subset of network cells from a set of network cells for communication with a network entity (base station 604) based on the update to the initial route. In some aspects, 704 may be performed by the route selection component 198.

At 706, the UE may communicate with the network entity via the subset of network cells. For example, referring to FIG. 6, the UE 602 may, at 618, communicate with the network entity (base station 604) via the subset of network cells. Referring to FIG. 4, the subset of network cells may include cell 0 410, cell 1 411, cell 2 412, cell 3 413, cell 4 414. In some aspects, 706 may be performed by the route selection component 198.

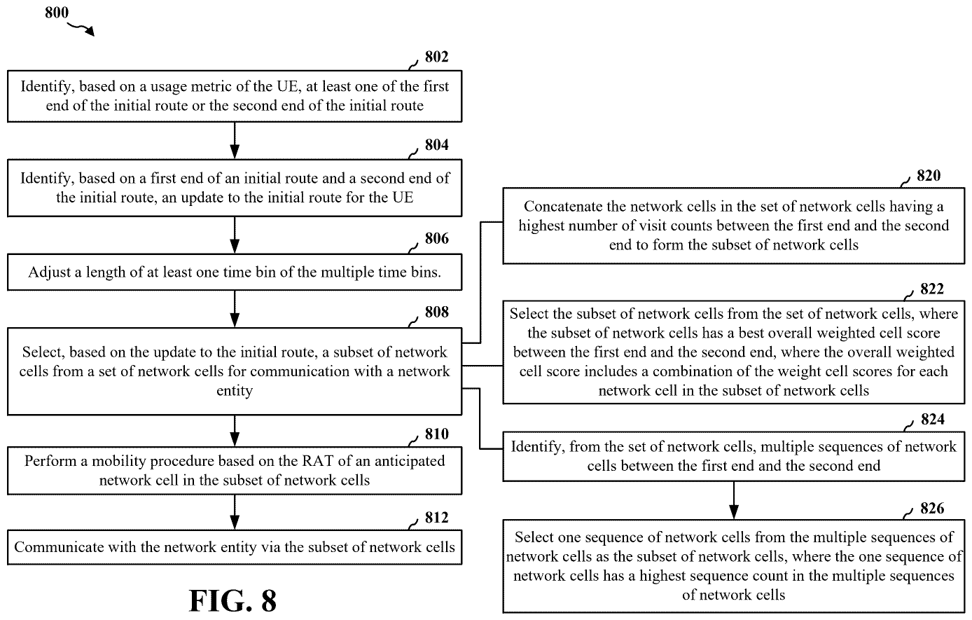

FIG. 8 is a flowchart 800 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 502, 602, or the apparatus 1104 in the hardware implementation of FIG. 11. By detecting frequently traveled routes and customizing the mobility strategy specifically for these detected routes, the methods may be used to detect distinct travel patterns and enhance user experiences and device functionalities during routine commutes. Additionally, by determining the routes based on cell visit counts within various time bins that reflect daily and weekly variations, the methods adapt to varying user schedules and mobility patterns, thereby improving the accuracy of route determination. In some examples, by choosing the highest-performing cells along these determined routes and avoiding problematic cells, the methods significantly enhance both the reliability and efficiency of wireless communication.

As shown in FIG. 8, at 804, the UE may identify an update to the initial route for the UE based on a first end of an initial route and a second end of the initial route. FIG. 4, FIG. 5, and FIG. 6 illustrate various aspects of the steps in connection with flowchart 800. For example, referring to FIG. 6, the UE 602 may, at 610, identify an update to the initial route for the UE 602 based on a first end of an initial route and a second end of the initial route. Referring to FIG. 5, if the UE 502 identifies that the start location of the route is home 532, this may suggest that the UE 502 is likely to be traveling along the route 530. In some aspects, 804 may be performed by the route selection component 198.

At 808, the UE may select a subset of network cells from a set of network cells for communication with a network entity based on the update to the initial route. For example, referring to FIG. 6, the UE 602 may, at 614, select a subset of network cells from a set of network cells for communication with a network entity (base station 604) based on the update to the initial route. In some aspects, 808 may be performed by the route selection component 198.

At 812, the UE may communicate with the network entity via the subset of network cells. For example, referring to FIG. 6, the UE 602 may, at 618, communicate with the network entity (base station 604) via the subset of network cells. Referring to FIG. 4, the subset of network cells may include cell 0 410, cell 1 411, cell 2 412, cell 3 413, cell 4 414. In some aspects, 812 may be performed by the route selection component 198.

In some aspects, at 802, the UE may identify, based on a usage metric of the UE, at least one of the first end of the initial route or the second end of the initial route. For example, referring to FIG. 6, the UE 602 may, at 608, identify, based on a usage metric of the UE, at least one of the first end of the initial route or the second end of the initial route. In some aspects, 802 may be performed by the route selection component 198.

In some aspects, the usage metric may include one or more of: the connection duration of the UE, the connection type of the UE, or the mobility level of the UE. For example, referring to FIG. 6, the usage metric may include one or more of: the connection duration (e.g., 620) of the UE 602, the connection type (e.g., 622) of the UE, or the mobility level (e.g., 624) of the UE.

In some aspects, the usage metric may include the connection duration of the UE, and to identify the at least one of the first end or the second end (e.g., at 802), the UE may set a location as one of the first end or the second end based on the connection duration on the location within a unit time window being larger than a duration threshold. For example, referring to FIG. 6, the usage metric may include the connection duration 620 of the UE 602. Referring to FIG. 5, if the UE 502 may set a location (e.g., home 532) as one of the first end or the second end based on the connection duration on the location (e.g., home 532) within a unit time window is larger than a duration threshold.

In some aspects, the usage metric may include the connection type of the UE, and to identify the at least one of the first end or the second end (e.g., at 802), the UE may set, based on an establishment of a first connection type at a first location, the first location as one of the first end or the second end; or set, based on a disconnection of the first connection type at the first location, the first location as one of the first end or the second end. For example, referring to FIG. 6, the usage metric may include the connection type 622 of the UE 602. Referring to FIG. 5, based on an establishment of a first connection type (e.g., the establishment of a Wi-Fi connection) at a first location (e.g., home 532), the UE 502 may set the first location as one of the first end or the second end. In some examples, the UE 502 may also set the first location (e.g., home 532) as one of the first end or the second end based on a disconnection of the first connection type (e.g., the disconnection of the Wi-Fi connection) at the first location. In some aspects, the usage metric may include the mobility level of the UE, and to identify at least one of the first end or the second end (e.g., at 802), the UE may set, based on a change of the mobility level at a location, the location as one of the first end or the second end. For example, referring to FIG. 6, the usage metric may include the mobility level 624 of the UE 602. Referring to FIG. 5, the UE 502 may set a location (e.g., office 534) as one of the first end or the second end based on a change of the mobility level at the location (e.g., a change in the speed of the UE 502 upon arriving the office 534).

In some aspects, the mobility level of the UE may be based on one or more of: the speed of the UE, the cell switch pattern for the UE, the displacement change, the signal variation pattern, or an indication from a sensor. For example, referring to FIG. 5, the mobility level of the UE 502 may be based on one or more of: the speed of the UE 502, the cell switch pattern for the UE 502, the displacement change, the signal variation pattern, or an indication from a sensor.

In some aspects, the UE may select the subset of network cells from the set of network cells based on a set of visit counts respectively corresponding to a set of network cells, and each visit count in the set of visit counts may include an accumulation of multiple individual counts respectively located in multiple time bins within a period of time, and the multiple time bins may be distributed in the period of time based on an interval. For example, referring to FIG. 6, the UE 602 may, at 630, select the subset of network cells from the set of network cells based on a set of visit counts respectively corresponding to a set of network cells. Referring to Table 3, each visit count in the set of visit counts may include an accumulation of multiple individual counts respectively located in multiple time bins within a period of time (e.g., 20 weeks), and the multiple time bins may be distributed in the period of time based on an interval (e.g., the time bins in Table 3 correspond to 7-8 am for each Monday over a 20-week period).

In some aspects, at 806, the UE may adjust a length of at least one time bin of the multiple time bins. For example, referring to Table 2, the length of the time bin may be adjustable. For example, during peak travel hours, such as 6-10 am or 4-8 pm, the duration of the time bins may be shorter (e.g., 15 minutes) to allow the UE to gather more detailed data. In some aspects, 806 may be performed by the route selection component 198.

In some aspects, to select the subset of network cells from the set of network cells (e.g., at 808), the UE may, at 820, concatenate the network cells in the set of network cells having the highest number of visit counts between the first end and the second end to form the subset of network cells. For example, referring to FIG. 6, the UE 602 may, at 630, concatenate the network cells in the set of network cells having the highest number of visit counts between the first end and the second end to form the subset of network cells. Referring to FIG. 4 and Table 3, based on the cell visit counts for the network cells, the selected subset of network cells may include cell 0 410, cell 1 411, cell 2 412, cell 3 413, and cell 4 414, which have the highest visit counts among the cells that connect the two ends of the route (e.g., home 432 and office 434). In some aspects, 820 may be performed by the route selection component 198.

In some aspects, the highest number of visit counts may include the summation of the visit counts over a time window, where the time window includes one or more time bins of the multiple time bins. For example, referring to Table 3, the highest number of visit counts (e.g., the visit counts of 20, 20, 18, 18, 15 for cell 0, cell 1, cell 2, cell 3, cell 4, respectively) may include the summation of the visit counts over a time window (e.g., 20 weeks), and the time window includes one or more time bins of the multiple time bins.

In some aspects, to select the subset of network cells from the set of network cells (e.g., at 808), the UE may, at 824, identify, from the set of network cells, multiple sequences of network cells between the first end and the second end; and, at 826, select one sequence of network cells from the multiple sequences of network cells as the subset of network cells, where the one sequence of network cells has the highest sequence count in the multiple sequences of network cells. For example, referring to FIG. 6, the UE 602 may identify multiple sequences of network cells between the first end and the second end and, at 632, select one sequence of network cells from the multiple sequences of network cells as the subset of network cells. Referring to Table 4, the UE may select sequence S1={0,1,2,3,4} (each number represents one cell) of network cells since the sequence S1 has a higher sequence count than other sequences of network cells (e.g., S2={0,1,10,2,3,4} or S3={0,1,2,11,12,4}). In some aspects, 824 and 826 may be performed by the route selection component 198.

In some aspects, to identify the update to the initial route for the UE (e.g., at 804), the UE may predict the update to the initial route based on one or more of: a match between the first end or the second end to an end of an identified route, a comparison of visited network cells between the first end and the second end and the network cells associated with the identified route, the comparison of a travel time with an estimated travel time associated with the identified route, or a change in a connection type of the UE.

In some aspects, each network cell in the set of network cells may be associated with a weighted cell score, and the weighted cell score for the network cell is based on one or more of: a quality measurement of the network cell, where the quality measurement includes one or more of: a reference signal received power (RSRP) or a reference signal received quality (RSRQ) of the network cell, a degree of problem (DoP) metric of the network cell, a desired metric of the network cell, or a type of the communication for the network cell. In some examples, the weighted cell score for a network cell may consider factors such as the cell bandwidth, the MIMO layer configuration, and the SNR associated with the network cell. For example, referring to FIG. 5, each network cell in the set of network cells (e.g., cells 510, 511, 512, 513, 514, 515, 516) may be associated with a weighted cell score, and the weighted cell score for the network cell is based on one or more of: a quality measurement of the network cell. The quality measurement includes one or more of: the RSRP or RSRQ of the network cell, the DoP metric of the network cell, the desired metric of the network cell, or the type of the communication for the network cell. In some examples, the weighted cell score for a network cell (e.g., cells 510, 511, 512, 513, 514, 515, 516) may consider factors such as the cell bandwidth, the MIMO layer configuration, and the SNR associated with these network cells (e.g., cells 510, 511, 512, 513, 514, 515, 516).

In some aspects, the DoP metric of the network cell may include the weighted sum for issues observed on the network cell, and the issues may include one or more of: a data stall with the network cell, or a radio link failure (RLF) of the network cell, a connection establishment failure, the failure to receive important configurations, the presence of ping-pong mobility, or a misconfiguration by the network. For example, referring to FIG. 5, the DoP metric of the network cell (e.g., cells 510, 511, 512, 513, 514, 515, 516) may include the weighted sum for issues observed on the network cell, and the issues may include one or more of: a data stall with the network cell, or the RLF of the network cell, a connection establishment failure, the failure to receive important configurations, the presence of ping-pong mobility, or a misconfiguration by the network.

In some aspects, to select the subset of network cells from the set of network cells (e.g., at 808), the UE may, at 822, select the subset of network cells from the set of network cells, where the subset of network cells has a best overall weighted cell score between the first end and the second end, and the overall weighted cell score includes a combination of the weight cell scores for each network cell in the subset of network cells. For example, referring to FIG. 6, the UE 602 may, at 634, select the subset of network cells that have the best overall weighted cell score between the first end and the second end from the set of network cells. In some aspects, 822 may be performed by the route selection component 198.

In some aspects, each network cell of the set of network cells may be associated with a radio access technology (RAT). At 810, the UE may perform a mobility procedure based on the RAT of an anticipated network cell in the subset of network cells. For example, referring to FIG. 6, the UE 602, may, at 616, perform a mobility procedure based on the RAT of an anticipated network cell in the subset of network cells. In some aspects, 810 may be performed by the route selection component 198.

In some aspects, the mobility procedure may include one or more of: a cell selection procedure or a cell reselection procedure, a desired search based on the RAT of the anticipated network cell, a change in a reselection priority based on the RAT of the anticipated network cell, the change in a report priority based on the RAT of the anticipated network cell, or the change in a RAT scan priority based on the RAT of the anticipated network cell. For example, referring to FIG. 5, the mobility procedure may include one or more of: a cell selection procedure or a cell reselection procedure, a desired search based on the RAT of the anticipated network cell (e.g., cells 510, 511, 512, 513, 514, 515, 516), a change in a reselection priority based on the RAT of the anticipated network cell (e.g., cells 510, 511, 512, 513, 514, 515, 516), the change in a report priority based on the RAT of the anticipated network cell (e.g., cells 510, 511, 512, 513, 514, 515, 516), or the change in a RAT scan priority based on the RAT of the anticipated network cell (e.g., cells 510, 511, 512, 513, 514, 515, 516).

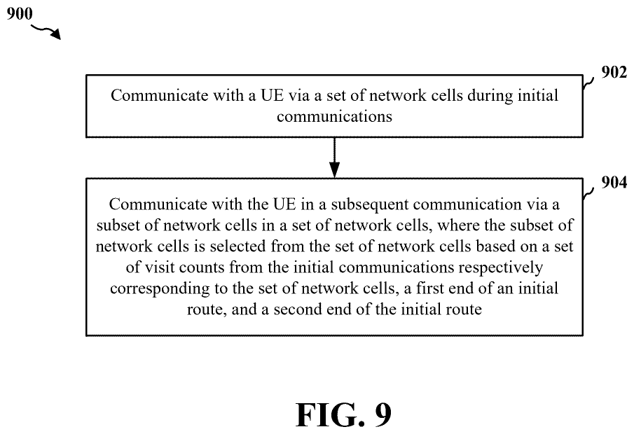

FIG. 9 is a flowchart 900 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 502, 602, or the apparatus 1104 in the hardware implementation of FIG. 11. By detecting frequently traveled routes and customizing the mobility strategy specifically for these detected routes, the methods may be used to detect distinct travel patterns and enhance user experiences and device functionalities during routine commutes. Additionally, by determining the routes based on cell visit counts within various time bins that reflect daily and weekly variations, the methods adapt to varying user schedules and mobility patterns, thereby improving the accuracy of route determination. In some examples, by choosing the highest-performing cells along these determined routes and avoiding problematic cells, the methods significantly enhance both the reliability and efficiency of wireless communication.

As shown in FIG. 9, at 902, the network entity may communicate with a UE via a set of network cells during initial communications. FIG. 4, FIG. 5, and FIG. 6 illustrate various aspects of the steps in connection with flowchart 900. For example, referring to FIG. 6, the network entity (base station 604) may, at 606, communicate with a UE 602 via a set of network cells during initial communications. Referring to FIG. 5, the set of network cells may include cells 510, 511, 512, 513, 514, 515, 516. In some aspects, 902 may be performed by the route selection component 199.

At 904, the network entity may communicate with the UE in a subsequent communication via a subset of network cells in a set of network cells. The subset of network cells may be selected from the set of network cells based on a set of visit counts from the initial communications respectively corresponding to the set of network cells, a first end of an initial route, and a second end of the initial route. For example, referring to FIG. 6, the network entity (base station 604) may, at 618, communicate with the UE 602 in a subsequent communication via a subset of network cells in a set of network cells. The subset of network cells may be selected from the set of network cells based on a set of visit counts from the initial communications respectively corresponding to the set of network cells, a first end of an initial route, and a second end of the initial route. In some aspects, 904 may be performed by the route selection component 199.

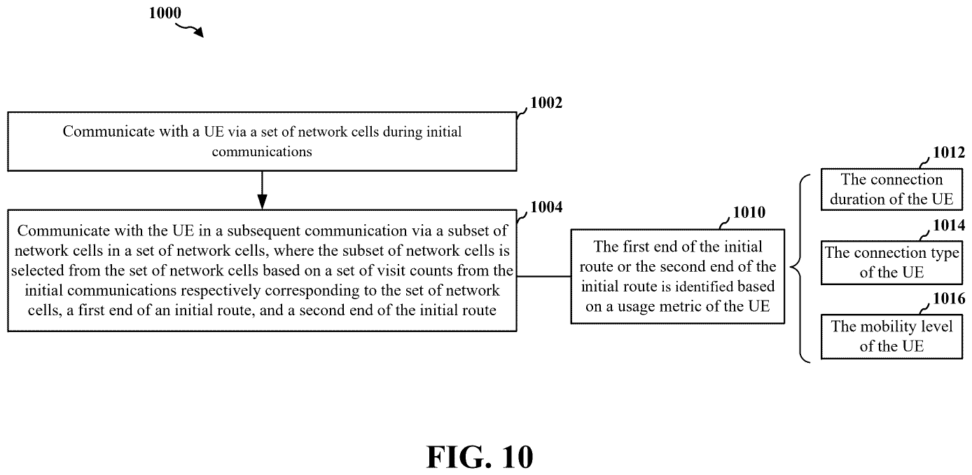

FIG. 10 is a flowchart 1000 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 604; or the network entity 1102 in the hardware implementation of FIG. 11). The UE may be the UE 104, 350, 502, 602, or the apparatus 1104 in the hardware implementation of FIG. 11. By detecting frequently traveled routes and customizing the mobility strategy specifically for these detected routes, the methods may be used to detect distinct travel patterns and enhance user experiences and device functionalities during routine commutes. Additionally, by determining the routes based on cell visit counts within various time bins that reflect daily and weekly variations, the methods adapt to varying user schedules and mobility patterns, thereby improving the accuracy of route determination. In some examples, by choosing the highest-performing cells along these determined routes and avoiding problematic cells, the methods significantly enhance both the reliability and efficiency of wireless communication.

As shown in FIG. 10, at 1002, the network entity may communicate with a UE via a set of network cells during initial communications. FIG. 4, FIG. 5, and FIG. 6 illustrate various aspects of the steps in connection with flowchart 1000. For example, referring to FIG. 6, the network entity (base station 604) may, at 606, communicate with a UE 602 via a set of network cells during initial communications. Referring to FIG. 5, the set of network cells may include cells 510, 511, 512, 513, 514, 515, 516. In some aspects, 1002 may be performed by the route selection component 199.

At 1004, the network entity may communicate with the UE in a subsequent communication via a subset of network cells in a set of network cells. The subset of network cells may be selected from the set of network cells based on a set of visit counts from the initial communications respectively corresponding to the set of network cells, a first end of an initial route, and a second end of the initial route. For example, referring to FIG. 6, the network entity (base station 604) may, at 618, communicate with the UE 602 in a subsequent communication via a subset of network cells in a set of network cells. The subset of network cells may be selected from the set of network cells based on a set of visit counts from the initial communications respectively corresponding to the set of network cells, a first end of an initial route, and a second end of the initial route. In some aspects, 1004 may be performed by the route selection component 199.

In some aspects, at 1010, the first end of the initial route or the second end of the initial route may be identified based on a usage metric of the UE. For example, referring to FIG. 5, the first end (e.g., home 532) of the initial route (e.g., route 530) or the second end (e.g., office 534) of the initial route (e.g., route 530) may be identified based on a usage metric of the UE 502.

In some aspects, the usage metric includes one or more of: the connection duration of the UE (e.g., at 1012), the connection type of the UE (e.g., at 1014), or the mobility level of the UE (e.g., at 1016). For example, referring to FIG. 6, the usage metric includes one or more of: the connection duration (e.g., 620) of the UE 602, the connection type (e.g., 622) of the UE 602, or the mobility level (e.g., 624) of the UE 602.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to identify, based on a first end of an initial route and a second end of the initial route, an update to the initial route for the UE; select, based on the update to the initial route, a subset of network cells from the set of network cells for communication with a network entity; and communicate with the network entity via the subset of network cells. The component 198 may be further configured to perform any of the aspects described in connection with the flowcharts in FIG. 7 and FIG. 8, and/or performed by the UE 602 in FIG. 6. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for identifying, based on a first end of an initial route and a second end of the initial route, an update to the initial route for the UE; means for selecting, based on the update to the initial route, a subset of network cells from the set of network cells for communication with a network entity; and means for communicating with the network entity via the subset of network cells. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

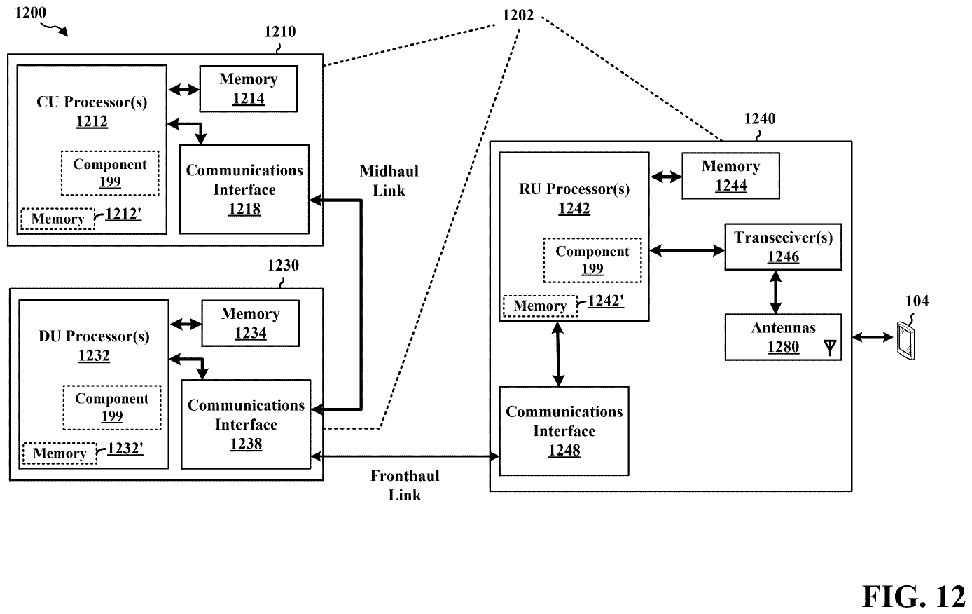

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to communicate with a UE via a set of network cells during initial communications; and communicate with the UE in a subsequent communication via a subset of network cells in a set of network cells, where the subset of network cells is selected from the set of network cells based on a set of visit counts from the initial communications respectively corresponding to the set of network cells, a first end of an initial route, and a second end of the initial route. The component 199 may be further configured to perform any of the aspects described in connection with the flowcharts in FIG. 9 and FIG. 10, and/or performed by the base station 604 in FIG. 6. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for communicating with a UE via a set of network cells during initial communications; and means for communicating with the UE in a subsequent communication via a subset of network cells in a set of network cells, where the subset of network cells is selected from the set of network cells based on a set of visit counts from the initial communications respectively corresponding to the set of network cells, a first end of an initial route, and a second end of the initial route. The network entity 1202 may further include means for performing any of the aspects described in connection with the flowcharts in FIG. 9 and FIG. 10, and/or aspects performed by the base station 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include identifying, based on a first end of an initial route and a second end of the initial route, an update to the initial route for the UE; selecting, based on the update to the initial route, a subset of network cells from the set of network cells for communication with a network entity; and communicating with the network entity via the subset of network cells. By detecting frequently traveled routes and customizing the mobility strategy specifically for these detected routes, the methods may be used to detect distinct travel patterns and enhance user experiences and device functionalities during routine commutes. Additionally, by determining the routes based on cell visit counts within various time bins that reflect daily and weekly variations, the methods adapt to varying user schedules and mobility patterns, thereby improving the accuracy of route determination. In some examples, by choosing the highest-performing cells along these determined routes and avoiding problematic cells, the methods significantly enhance both the reliability and efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes identifying, based on a first end of an initial route and a second end of the initial route, an update to the initial route for the UE; selecting, based on the update to the initial route, a subset of network cells from the set of network cells for communication with a network entity; and communicating with the network entity via the subset of network cells.

Aspect 2 is the method of aspect 1, where the method further includes identifying, based on a usage metric of the UE, at least one of the first end of the initial route or the second end of the initial route.

Aspect 3 is the method of aspect 2, wherein the usage metric includes one or more of: a connection duration of the UE, a connection type of the UE, or a mobility level of the UE.

Aspect 4 is the method of any of aspects 2 to 3, wherein the usage metric includes the connection duration of the UE, and wherein identifying the at least one of the first end or the second end includes setting a location as one of the first end or the second end based on the connection duration on the location within a unit time window being larger than a duration threshold.

Aspect 5 is the method of any of aspects 2 to 3, wherein the usage metric includes the connection type of the UE, and wherein identifying the at least one of the first end or the second end includes setting, based on an establishment of a first connection type at a first location, the first location as one of the first end or the second end; or setting, based on a disconnection of the first connection type at the first location, the first location as one of the first end or the second end.

Aspect 6 is the method of any of aspects 2 to 3, wherein the usage metric includes the mobility level of the UE, and wherein identifying at least one of the first end or the second end includes setting, based on a change of the mobility level at a location, the location as one of the first end or the second end.

Aspect 7 is the method of aspect 6, wherein the mobility level of the UE is based on one or more of: a speed of the UE, a cell switch pattern for the UE, a displacement change, a signal variation pattern, or an indication from a sensor.

Aspect 8 is the method of any of aspects 1 to 7, wherein selecting the subset of network cells from the set of network cells comprises: selecting, based on a set of visit counts respectively corresponding to a set of network cells, the subset of network cells from the set of network cells, wherein each visit count in the set of visit counts includes an accumulation of multiple individual counts respectively located in multiple time bins within a period of time, and wherein the multiple time bins are distributed in the period of time based on an interval.

Aspect 9 is the method of aspect 8, wherein the method further includes adjusting a length of at least one time bin of the multiple time bins.

Aspect 10 is the method of aspect 8, wherein selecting the subset of network cells from the set of network cells includes concatenating the network cells in the set of network cells having a highest number of visit counts between the first end and the second end to form the subset of network cells.

Aspect 11 is the method of aspect 10, wherein the highest number of visit counts includes a summation of the visit counts over a time window, wherein the time window includes one or more time bins of the multiple time bins.

Aspect 12 is the method of aspect 8, wherein selecting the subset of network cells from the set of network cells includes identifying, from the set of network cells, multiple sequences of network cells between the first end and the second end; and selecting one sequence of network cells from the multiple sequences of network cells as the subset of network cells, wherein the one sequence of network cells has a highest sequence count in the multiple sequences of network cells.

Aspect 13 is the method of aspect 8, wherein identifying the update to the initial route for the UE includes predicting the update to the initial route based on one or more of: a match between the first end or the second end to an end of an identified route, a comparison of visited network cells between the first end and the second end and the network cells associated with the identified route, the comparison of a travel time with an estimated travel time associated with the identified route, or a change in a connection type of the UE.

Aspect 14 is the method of aspect 8, wherein each network cell in the set of network cells is associated with a weighted cell score, wherein the weighted cell score for the network cell is based on one or more of: a quality measurement of the network cell, wherein the quality measurement includes one or more of: a reference signal received power (RSRP) or a reference signal received quality (RSRQ) of the network cell, a degree of problem (DoP) metric of the network cell, a desired metric of the network cell, or a type of the communication for the network cell.

Aspect 15 is the method of aspect 14, wherein the DoP metric of the network cell includes a weighted sum for issues observed on the network cell, wherein the issues include one or more of: a data stall with the network cell, or a radio link failure (RLF) of the network cell, a connection establishment failure, a failure to receive important configurations, a presence of ping-pong mobility, or a misconfiguration by a network.

Aspect 16 is the method of aspect 14, wherein selecting the subset of network cells from the set of network cells includes selecting the subset of network cells from the set of network cells, wherein the subset of network cells has a best overall weighted cell score between the first end and the second end, wherein the overall weighted cell score includes a combination of the weight cell scores for each network cell in the subset of network cells.

Aspect 17 is the method of aspect 14, wherein each network cell of the set of network cells is associated with a radio access technology (RAT), and wherein the method further includes performing a mobility procedure based on the RAT of an anticipated network cell in the subset of network cells.

Aspect 18 is the method of aspect 17, wherein the mobility procedure includes one or more of: a cell selection procedure or a cell reselection procedure, a desired search based on the RAT of the anticipated network cell, a change in a reselection priority based on the RAT of the anticipated network cell, the change in a report priority based on the RAT of the anticipated network cell, or the change in a RAT scan priority based on the RAT of the anticipated network cell.

Aspect 19 is an apparatus for wireless communication at a UE, comprising: a processing system that includes processor circuitry and memory circuitry that stores code and is coupled with the processor circuitry, the processing system configured to perform the method of one or more of aspects 1-18.

Aspect 20 is an apparatus for wireless communication at a UE, comprising: at least one memory; and at least one processor coupled to the at least one memory and, where the at least one processor is configured to perform the method of any of aspects 1-18.

Aspect 21 is the apparatus for wireless communication at a UE, comprising means for performing each step in the method of any of aspects 1-18.

Aspect 22 is an apparatus of any of aspects 19-21, further comprising a transceiver configured to receive or to transmit in association with the method of any of aspects 1-18.

Aspect 23 is a computer-readable medium (e.g., a non-transitory computer-readable medium) storing computer executable code at a UE, the code when executed by at least one processor causes the at least one processor to perform the method of any of aspects 1-18.

Aspect 24 is a method of wireless communication at a network entity. The method includes communicating with a user equipment (UE) via a set of network cells during initial communications; and communicating with the UE in a subsequent communication via a subset of network cells in a set of network cells, wherein the subset of network cells is selected from the set of network cells based on a set of visit counts from the initial communications respectively corresponding to the set of network cells, a first end of an initial route, and a second end of the initial route.

Aspect 25 is the method of aspect 24, wherein the first end of the initial route or the second end of the initial route is identified based on a usage metric of the UE.

Aspect 26 is the method of aspect 25, wherein the usage metric includes one or more of: a connection duration of the UE, a connection type of the UE, or a mobility level of the UE.

Aspect 27 is an apparatus for wireless communication at a network entity, comprising: a processing system that includes processor circuitry and memory circuitry that stores code and is coupled with the processor circuitry, the processing system configured to cause the network entity to perform the method of one or more of aspects 24-26.

Aspect 28 is an apparatus for wireless communication at a network entity, comprising: at least one memory; and at least one processor coupled to the at least one memory and, where the at least one processor is configured to perform the method of any of aspects 24-26.

Aspect 29 is the apparatus for wireless communication at a network entity, comprising means for performing each step in the method of any of aspects 24-26.

Aspect 30 is an apparatus of any of aspects 27-29, further comprising a transceiver configured to receive or to transmit in association with the method of any of aspects 24-26.

Aspect 31 is a computer-readable medium (e.g., a non-transitory computer-readable medium) storing computer executable code at a network entity, the code when executed by at least one processor causes the at least one processor to perform the method of any of aspects 24-26.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
identify, based on a first end of an initial route and a second end of the initial route, an update to the initial route for the UE;
select, based on the update to the initial route, a subset of network cells from a set of network cells for communication with a network entity; and
communicate with the network entity via the subset of network cells.

2. The apparatus of claim 1, further comprising a transceiver coupled to the at least one processor, wherein to communicate with the network entity via the subset of network cells, the at least one processor is configured to communicate with the network entity via the subset of network cells via the transceiver, and wherein the at least one processor is further configured to:
identify, based on a usage metric of the UE, at least one of the first end of the initial route or the second end of the initial route.

3. The apparatus of claim 2, wherein the usage metric includes one or more of:
a connection duration of the UE,
a connection type of the UE, or
a mobility level of the UE.

4. The apparatus of claim 3, wherein the usage metric includes the connection duration of the UE, and wherein to identify the at least one of the first end or the second end, the at least one processor is configured to:
set a location as one of the first end or the second end based on the connection duration on the location within a unit time window being larger than a duration threshold.

5. The apparatus of claim 3, wherein the usage metric includes the connection type of the UE, and wherein to identify the at least one of the first end or the second end, the at least one processor is configured to:
set, based on an establishment of a first connection type at a first location, the first location as one of the first end or the second end; or
set, based on a disconnection of the first connection type at the first location, the first location as one of the first end or the second end.

6. The apparatus of claim 3, wherein the usage metric includes the mobility level of the UE, and wherein to identify at least one of the first end or the second end, the at least one processor is configured to:
set, based on a change of the mobility level at a location, the location as one of the first end or the second end.

7. The apparatus of claim 6, wherein the mobility level of the UE is based on one or more of:
a speed of the UE,
a cell switch pattern for the UE,
a displacement change,
a signal variation pattern, or
an indication from a sensor.

8. The apparatus of claim 1, wherein to select the subset of network cells from the set of network cells, the at least one processor is further configured to:
select, based on a set of visit counts respectively corresponding to the set of network cells, the subset of network cells from the set of network cells, wherein each visit count in the set of visit counts includes an accumulation of multiple individual counts respectively located in multiple time bins within a period of time, and wherein the multiple time bins are distributed in the period of time based on an interval.

9. The apparatus of claim 8, wherein the at least one processor is further configured to:
adjust a length of at least one time bin of the multiple time bins.

10. The apparatus of claim 8, wherein to select the subset of network cells from the set of network cells, the at least one processor is configured to:
concatenate the network cells in the set of network cells having a highest number of visit counts between the first end and the second end to form the subset of network cells.

11. The apparatus of claim 10, wherein the highest number of visit counts includes a summation of the visit counts over a time window, wherein the time window includes one or more time bins of the multiple time bins.

12. The apparatus of claim 8, wherein to select the subset of network cells from the set of network cells, the at least one processor is configured to:
identify, from the set of network cells, multiple sequences of network cells between the first end and the second end; and
select one sequence of network cells from the multiple sequences of network cells as the subset of network cells, wherein the one sequence of network cells has a highest sequence count in the multiple sequences of network cells.

13. The apparatus of claim 8, wherein to identify the update to the initial route for the UE, the at least one processor is configured to:
predict the update to the initial route based on one or more of:
a match between the first end or the second end to an end of an identified route,
a comparison of visited network cells between the first end and the second end and the network cells associated with the identified route,
the comparison of a travel time with an estimated travel time associated with the identified route, or
a change in a connection type of the UE.

14. The apparatus of claim 8, wherein each network cell in the set of network cells is associated with a weighted cell score, wherein the weighted cell score for the network cell is based on one or more of:
a quality measurement of the network cell, wherein the quality measurement includes one or more of: a reference signal received power (RSRP) or a reference signal received quality (RSRQ) of the network cell,
a degree of problem (DoP) metric of the network cell,
a desired metric of the network cell, or
a type of the communication for the network cell.

15. The apparatus of claim 14, wherein the DoP metric of the network cell includes a weighted sum for issues observed on the network cell, wherein the issues include one or more of:
a data stall with the network cell,
a radio link failure (RLF) of the network cell,
a connection establishment failure,
a failure to receive important configurations,
a presence of ping-pong mobility, or
a misconfiguration by a network.

16. The apparatus of claim 14, wherein to select the subset of network cells from the set of network cells, the at least one processor is configured to:
select the subset of network cells from the set of network cells, wherein the subset of network cells has a best overall weighted cell score between the first end and the second end, wherein the overall weighted cell score includes a combination of the weight cell scores for each network cell in the subset of network cells.

17. The apparatus of claim 14, wherein each network cell of the set of network cells is associated with a radio access technology (RAT), and wherein the at least one processor is further configured to:
perform a mobility procedure based on the RAT of an anticipated network cell in the subset of network cells.

18. The apparatus of claim 17, wherein the mobility procedure includes one or more of:
a cell selection procedure or a cell reselection procedure,
a desired search based on the RAT of the anticipated network cell,
a change in a reselection priority based on the RAT of the anticipated network cell,
the change in a report priority based on the RAT of the anticipated network cell, or
the change in a RAT scan priority based on the RAT of the anticipated network cell.

19. A method of wireless communication at a user equipment (UE), comprising:
identifying, based on a first end of an initial route and a second end of the initial route, an update to the initial route for the UE;
selecting, based on the update to the initial route, a subset of network cells from a set of network cells for communication with a network entity; and
communicating with the network entity via the subset of network cells.

20. An apparatus for wireless communication at a network entity, comprising:
at least one memory; and
at least one processor coupled to the at least one memory and, based at least in part on information stored in the at least one memory, the at least one processor is configured to:
communicate with a user equipment (UE) via a set of network cells during initial communications; and
communicate with the UE in a subsequent communication via a subset of network cells in the set of network cells, wherein the subset of network cells is selected from the set of network cells based on a set of visit counts from the initial communications respectively corresponding to the set of network cells, a first end of an initial route, and a second end of the initial route.
